(19) United States
(12) Patent Application Publication
(10) Pub. No.: US 2009/0000216 A1
(43) Pub. Date: Jan. 1, 2009

(54) COMPOSITE MATERIAL FOR PEST EXCLUSION

(75) Inventors: Terrence P. Kane, Glen Ellyn, IL (US); Kurt H. Schild, Wadsworth, IL (US)

Correspondence Address: ROSENBAUM & ASSOCIATES, P.C., 650 DUNDEE ROAD, SUITE #380, NORTHBROOK, IL, 60062, US

(73) Assignee: Global Material Technologies, Inc., Palatine, IL (US)

(21) Appl. No.: 12/140,130

(22) Filed: Jun. 16, 2008

Related U.S. Application Data
(60) Provisional application No. 60/944,322, filed on Jun. 15, 2007.

(51) Int. Cl. B32B 15/04; E04H 9/16

(52) U.S. Cl. 52/101; 428/605; 428/545

(57) ABSTRACT

The composite for pest control and deterrence comprises a mixture of metal and/or nonmetal fibers.

### CROSS-RELATED APPLICATIONS

The present application claims priority to U.S. Provisional Application Ser. No. 60/944,322, filed Jun. 15, 2007.

### BACKGROUND OF THE INVENTION

The field of the invention is pest control.

There are a variety of mechanisms for pest exclusion; however, currently there is a need in the art for economical pest exclusion device that is environmentally friendly and easily adaptable to a variety of environments and locations. Moreover, the current mechanisms for pest control are not very long lasting, lack resiliency, and susceptible to being pulled out by pests.

Rodents get into buildings through existing openings as small as ¼ of an inch or by gnawing and digging their own holes through walls, door frames, foundations or other barriers. Modern integrated pest management practices recommend that rodents be excluded from moving along their typical pathways and limiting their access to structures by sealing those openings with suitable means. The embodiments described herein solve these problems as well as others.

### SUMMARY OF THE INVENTION

The foregoing and other features and advantages are defined by the appended claims. The following detailed description of exemplary embodiments, read in conjunction with the accompanying drawings is merely illustrative rather than limiting, the scope being defined by the appended claims and equivalents thereof.

The composite for pest control and deterrence comprises an interengaged mixture of metal and nonmetal fibers, wherein the metal fibers include barbed projections and a rough outer surface with irregular shape and the interengaged mixture is formed into a pest deterrence composite.

### BRIEF DESCRIPTION OF THE FIGURES

The foregoing description of the figures is provided for a more complete understanding of the drawings. It should be understood, however, that the embodiments are not limited to the precise arrangements and configurations shown.

FIG. 1 is a cross section of one embodiment of the composite web.

FIG. 2 is enlarged perspective view of the metal fibers.

FIG. 3 is an enlarged perspective view of the nonmetal fibers

FIG. 4 is a schematic view of the blending step and precard apparatus.

FIG. 5 is a schematic view of the carding machine and lapping apparatus.

FIG. 6 is a schematic view of the needle punching machine.

FIG. 7 is a schematic view of one embodiment of the heat fusing apparatus.

FIG. 8A is a perspective view of one embodiment of the bullet shaped plug and FIG. 8B is a perspective view of one embodiment of the bullet shaped plug.

FIG. 9 is a close up view of one embodiment of the composite web.

### DETAILED DESCRIPTION OF THE PREFERRED EMBODIMENTS

The methods, apparatuses, and systems can be understood more readily by reference to the following detailed description of the methods, apparatuses, and systems, and the following description of the Figures.

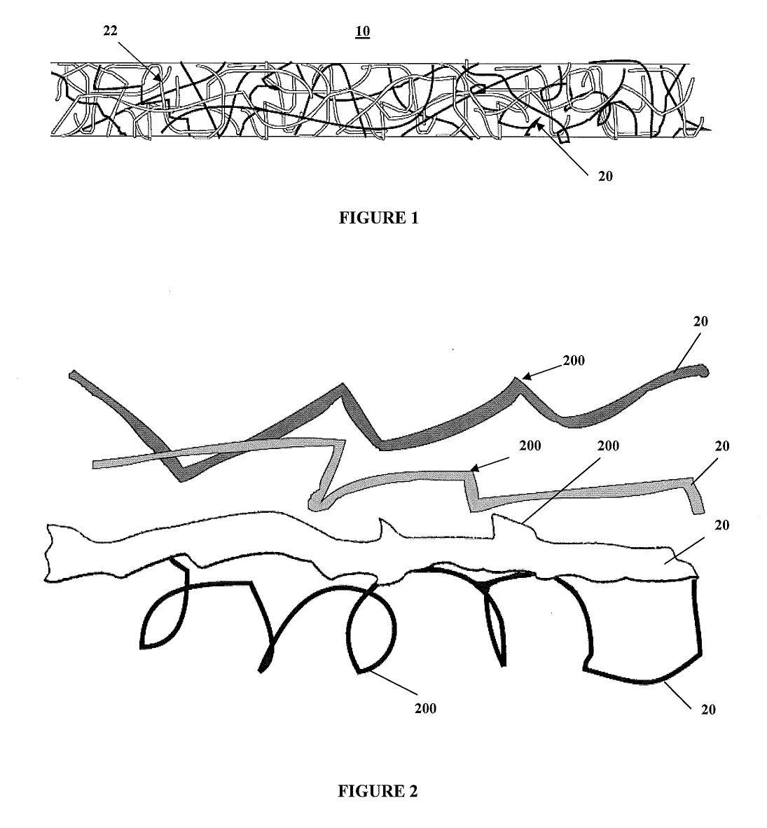

Generally speaking, in one embodiment, the composite web 10 comprises an interengaged mixture of a plurality of metal fibers and a plurality of nonmetal fibers, as shown in FIG. 1. The metal fibers and nonmetal fibers are interengaged and intertwined to provide for a density and resiliency for excluding pests in any environment. The composite web 10 deters pests by blocking passageways, openings, or by providing an inhospitable environment for pests. The composite web circumscribes an opening or passageway with resiliency and strength, as to obstruct pests. The increased resiliency and durability for pest deterrence and exclusion is provided for by the interengagement of the metal and nonmetal fibers. Small pests, such as insects, can become entrapped in the interengaged mixture of fibers; alternatively, pests are prevented from disassembling the composite web due to the interengagement of the fibers. The composite can be tightly packed into a gap, crack or weep hole, where the interengaged mixture resists being pulled out due to the resiliency of the composite. The interlocking nature of the metal fibers provides for a proficient barrier to pests, such as rodents, while having barbed projections that deter repeated attack by pests. The composite web 10 is substantially thick with minimal weight to prevent a pest from entering a structure. Resiliency can be radial resiliency or the ability of the composite web to return to its original shape after compressing, bending, or deformation when the composite web is placed into an obstruction pathway. The composite web 10 can be formed into the pest deterrence composite by molding the composite into any opening that is desired. The composite web is environmentally adapted to the outdoors or indoors, while not corroding or degrading.

Metal Fiber

In one embodiment, the plurality of metal fibers 20 is shown in FIG. 2. The metal fibers 20 include a random irregular cross-section and rough outer surfaces with barb projections 200 formed on the outer surfaces. The irregular cross-sections vary continuously along the length of the resulting fibers to provide generally curled metal fibers. The curled and barbed nature of the metal fibers allows strong interengagement and intertwining with each other and the nonmetal fibers. In one embodiment, the metal fibers 20 are produced by shaving a metal member with a succession of serrated blades, as disclosed in commonly assigned U.S. Pat. Nos. 6,249,941 and 5,972,814, which is hereby incorporated by reference. The succession of serrated blades has a variety of different serration patterns, so that the resulting individual fibers have barbed projections 200 and irregular cross sections with rough outer surfaces.

A suitable lubricant, such as oil, is preferably applied to the metal member as it is being shaved by the blades in sufficient quantity so that the metal fibers retain on their outer surface a carding-effective amount of the oil or lubricant. “Carding-effective amount” of oil or lubricant means that the metal fibers, when blended with the nonmetal fibers, can be carded without substantial breakage or disintegration. The lubricant optionally may be applied after the metal fibers are formed. The commonly assigned U.S. Pat. No. 5,972,814 discloses the process for shaving a metal bar to produce lubricated metal fibers and the use of such lubricated metal fibers. A carding-effective amount of oil generally may be in the range of about 0.3 to 1.0 wt. % oil, more preferably about 0.4 to 0.7 wt. %, based on the total weight of the metal fibers, although lesser or greater amounts may be used depending on the type and average diameter of the metal fibers and the amount and type of nonmetal fibers included in the blended fiber mixture. For example, as the weight percentage of nonmetal fibers relative to the metal fibers is decreased, the quantity of oil or lubricant necessary to provide a carding effective amount may tend to increase. Conversely, as the weight percentage of nonmetal fibers relative to metal fibers increases, the nonmetal fibers may act as a “carrier” for the metal fibers in the carding step, reducing the quantity of oil needed for carding without breakage of the metal fibers. Thus, a carding-effective amount of oil for carding various combinations and amounts of metal and nonmetal fibers can be readily determined on a case-by-case basis. Preferably, the metal fibers are made from stainless steel, as to prevent rusting and corrosion of the composite web. However, the metal fibers 20 can also be made from bronze, carbon steel, copper, metal alloys, and other suitable metals that can be shaved into suitable metal fibers to suit a variety of pest deterring applications. The metal fibers can have an average cross sectional diameter of between about 25 and 125 microns.

The metal fibers 20 are cut into staple lengths using a suitable metal fiber cutting apparatus to give the metal fibers a predetermined length, ranging between about 1 inch to about 12 inches, more preferably less than about 6 inches. In one embodiment, the metal fibers may have a length of about 6 inches prior to carding. In another embodiment, post carding web having metal fibers of approximately 1 to 3 inches long, due to a certain amount of fiber breakage occurs during the carding process. The metal fibers include a relatively high aspect ratio, where “aspect ratio” means ratio of fiber length to fiber diameter. In one embodiment, the aspect ratio may be about 75 to about 85, where the high aspect ratio results in an increased interengagement along the length of the metal fiber. Alternatively, the aspect ratio may be about 25 to about 75 for a lower aspect ratio in smaller composite web examples.

Nonmetal Fibers

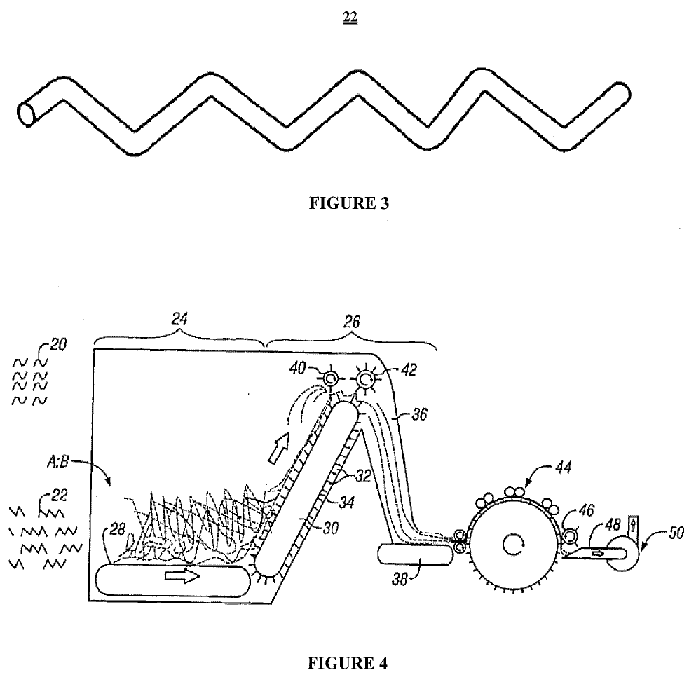

In one embodiment, the nonmetal fiber 22 is shown in FIG. 3. Such fibers may be essentially any synthetic or natural staple fibers conventionally used in the textile industry for making nonwoven fabric material, such as polypropylene, polyester, polyethylene, rayon, nylon, acetate, acrylic, cotton, wool, olefin, amide, polyamide, fiberglass and the like. In another embodiment, the nonmetal fibers are a bicomponent fiber. Bicomponent fibers are fibers extruded from two polymers from the same spinneret with both polymers contained within the same filament. The bicomponent fibers can be configured as sheath/core, side-by-side, or eccentric sheath/core arrangement. The bicomponent fibers provide for a uniform distribution of adhesive polymer to bind metal fibers and provide resiliency to the composite web. The bicomponent fiber remains a part of composite web structure after laminating steps and adds integrity to the composite web structure. And, the bicomponent fiber provides sufficient lamination, molding, and densification of the composite web to give durability and prevent pests from removing the composite web. The bicomponent fiber can also increase the resiliency of the composite web by including various

The lengths of the nonmetal fibers may be from about 1 inch to about 12 inches, and are more preferably less than about 6 inches in length. In one embodiment, the nonmetal fibers have a length from about 1 to 3 inches. The nonmetal fibers may be cut to size by conventional means. The nonmetal fibers are less brittle than the metal fibers, and are generally unaffected by the carding process. The grade of the nonmetal fibers may range from about 1 denier to about 120 denier. In another embodiment, the nonmetal fibers may range from about 10 to 80 denier, or alternatively from about 18 to 60 denier. In general, the metal fibers will have an average cross-sectional diameter that is from ½ to 2-times the cross-sectional diameter of the nonmetal fibers. Alternatively, the metal fibers and nonmetal fibers will have similar average diameters and lengths. In one embodiment, composite web comprises synthetic polymer fibers, such as polyester or polypropylene fibers, having a grade of about 60 denier and metal fibers having an average cross section of about 60 microns. In another embodiment, the composite web comprises bicomponent fibers having a 12 denier and metal fibers having an average cross section of about 60 microns.

Crimped synthetic fibers having a repeating “V” shape along their length such as that shown in FIG. 3, are known in the art. Crimped synthetic fibers have about 3 to 10 “V” shaped crimps per inch. Crimped fibers having about 7 crimps per inch being the most preferred. Of course, a greater or lesser degree of crimping may be selected as the particular application demands. Such crimped synthetic fibers are generally employed because they are readily carded by a garnett or carding machine and the crimped fibers increase the resiliency of the composite web. Various crimped fibers may be used include carded fibers, spunbond fibers, bicomponent fibers, and meltblown fibers.

In another embodiment, the composite web 10 has a ratio of metal fibers to non-metal fibers of between about 10:1 and about 99:10, by weight. In another embodiment of the invention, the composite web 10 comprises about 75 to 95 wt. % metal fibers and about 5 to 25 wt. % nonmetal fibers. Alternatively, the composite web comprises about 85 to 92 wt. % metal fibers and about 8 to 15 wt. % nonmetal fibers.

As will be appreciated by those skilled in the art, metal fibers are several fold denser than nonmetal fibers—that is the specific gravity of metal fibers is substantially greater than the specific gravity of synthetic fibers and other nonmetal fibers. Accordingly, it will be understood that composite web may have relatively similar numbers of metal fibers and nonmetal fibers, even though, on a weight percent basis, the composite web is mostly metal.

It will also be appreciated by the person having ordinary skill in the art that “denier” is a measure of specific weight (or fineness) of a fiber which is arrived at by weighing a predetermined length of the fiber. (One denier equals 0.05 grams per 450 meters). Accordingly, different nonmetal fabrics having the same denier may have different cross-sectional diameters.

Construction of Composite Web

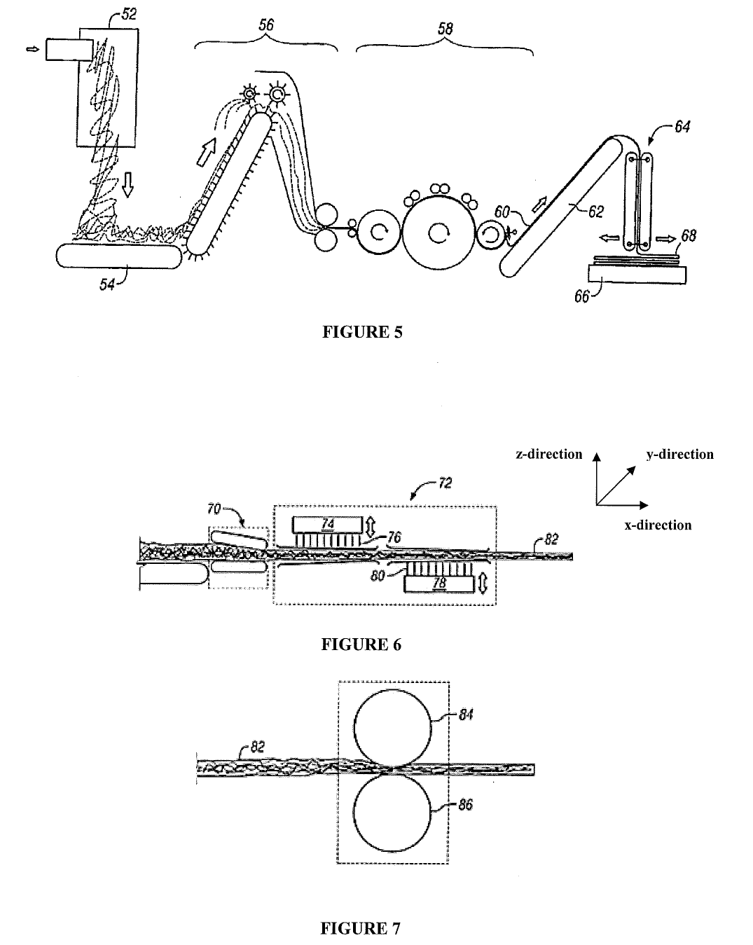

The composite is made by blending a predetermined amount of metal fibers 20 and a predetermined amount of nonmetal fibers 22 to provide a blend of metal and nonmetal fibers; carding the blended fibers to form a fiber web having metal fibers and nonmetal fibers distributed throughout; lapping the fiber web into a multilayered web structure; and needle punching the multilayered web structure to interengaged the fibers in adjacent layers to provide the composite web, as shown in FIGS. 4 and 5, and disclosed in commonly assigned U.S. Pat. Nos. 6,502,289 and 6,919,117, herein incorporated by reference.

In the blending step, the metal fibers 20 and nonmetal fibers 22 are blended prior to the carding step to obtain a substantially homogeneous mixture of the fibers, as disclosed in the commonly assigned U.S. Pat. No. 6,502,289. The blending of the staple fibers may be accomplished by various mechanical means. In one embodiment, two or more types of fibers may be mixed in an apparatus that is commonly known as a feedbox or blender and then fed directly into a carding apparatus. In another embodiment, a tandem feedbox arrangement may be used, that is an apparatus comprising two feedboxes in series, with the fibers being fed from the second feedbox directly into a carding apparatus. In another embodiment, the blending step may be performed by a series of apparatuses including a single feedbox, a precard machine to open up both the metal and nonmetal fibers and blend them, and a stock fan blower. Other, more elaborate blending lines may be used in the blending step. Any of these foregoing blending methods are suitable for use in accordance with the embodiments, depending on the degree of homogeneity desired for the composite web.

In one embodiment, a predetermined weight of staple length, shaved stainless steel fibers 20 (60 micron average diameter, 0.6% oil by weight) and staple length polyester fibers 22 (60 denier, 7 crimps per inch) are introduced into a hopper 24 of a feedbox 26 in a ratio of about 91 wt. % metal fibers (including oil) to 9 wt. % nonmetal fibers. As shown in FIG. 4, the hopper 24 has a hopper conveyor 28 that conveys the fibers to an incline conveyor 30 having a plurality of tines 32 extending from the conveyor belt 34, as to engage and carrying randomly oriented fibers 20, 22 up the incline conveyor 30. The feedbox 26 has a first spiked roller 40 which is spaced apart from incline conveyor 30 by a predetermined amount and rotates counter to the direction of travel of the incline conveyor 30. The incline conveyor 30 and the first spiked roller 40 comb the material to allow only a certain small amount of generally parallel fibers in a loose unstructured web to pass into a chute 36. A second spiked roller 42 rotating in the direction of travel of the conveyor assists in removing the thin layer of fibers 20, 22 from the tines 32 of the conveyor 30. The combing action of the first spiked roller 40 removes excess fibers which are “recycled”, or knocked back into the feedbox for further blending, resulting in a satisfactory distribution of metal 20 and non-metal fibers 22.

In FIG. 4, the individual fibers 20, 22 that pass under first spike roller 40 drop through the chute 36 and onto a precard conveyor 38, and then are advanced through to a precard apparatus 44 to form an open precard web 46 of loosely entwined fibers 20, 22. As the precard web 46 exits the precard apparatus 44, the precard web 46 is sucked into an intake 48 of a stock blower fan 50, and then is blown into a condenser box 52 causing the fibers 20, 22 of precard web 46 to be randomized, as shown in FIG. 5. The fibers 20, 22 then exit the condenser box 52 and are fed by a second feedbox conveyor 54 into a second feedbox 56, which is substantially identical to feedbox 26, which further mixes/blends fibers 20, 22 as indicated previously.

The blend of fibers 20, 22 is fed from second feedbox 56 into a shaker chute, and then into the garnett 58 and is formed into a web 60, as shown in FIG. 5. The web 60 is transported to an incline conveyor 62 and into a lapping apparatus 64, where the web 60 is lapped to form a multi-layered structure 68. The lapping apparatus 64 feeds the web 60 downwardly onto an apron 66, while simultaneously moving the web 60 from side to side in an oscillating motion (as depicted by the arrows) to cause the web material to invert and fold-over upon itself each time the oscillating lapper changes direction. While the lapping apparatus 64 deposits successive layers of the web 60 on top of each other, apron 66 advances slowly in a direction perpendicular the axis of oscillation so that the web 60 is laid down in a Z-shaped pattern as the fabric inverts and folds back upon itself. In this manner, a continuous-length of a multi-layered composite web structure 68 is formed. As will be appreciated by those having ordinary skill in the art, the lapping step causes adjacent layers of web 60 to be laid on top of each other at a preselected angle. Because the fibers in each layer are relatively aligned, the direction of the fibers in adjacent layers of the composite web runs on the bias with respect to one another. The number of layers in the multi-layered web structure 68 as well as the degree of the bias between adjacent layers will be a function of the following variables: (i) the speed at which the composite web 60 is advanced through the lapping apparatus 64; (ii) the frequency of oscillation of the lapping apparatus 64; (iii) the width of the composite web 60; and (iv) the apron 66 speed. In one embodiment, the web 60 is advanced on the lapping apparatus 64 at a speed of 47 feet per minute, and the lapping machine is oscillated at between 2-10 oscillations per minute. In another embodiment, the width of the web is between 20 to 60 inches and the apron speed is set between 5 to 50 feet per minute. However, the material can be manufactured on larger textile equipment that can produce widths of material up to 200 inches.

The multi-layered web structure 68 is then fed through a compression apron 70, as shown in FIG. 6, to slightly compress the multi-layered structure 68, and needled by a needle-punch apparatus 72 to form a composite web 10. The needle-punch apparatus 72 comprises a first punch board 74 having a first set of barbed needles 76. The first punch board 74 reciprocates up and down and punches the multi-layered composite web 68 from the top side to interengage fibers on the down-stroke. The needle-punch apparatus 72 further comprises a second punch board 78 having a second set of barbed needles 80. The second punch board 78 reciprocates up and down and punches the multi-layered composite web 68 from the underside to interengage fibers on the upstroke. The resulting needle punched composite web forms the composite web 10. The interengagement of the metal and nonmetal fibers provides for an neighboring fibers in an orientation for strong intertwining and interengaging to increase resiliency and durability for pest deterrence and exclusion.

The composite web may be needlepunched to a low penetration of a needle per square inch (“PPSI”) so that the puncture density will maintain the resiliency of the composite web and compress the metal and nonmetal fibers to a sufficient degree. PPSI is a function of strokes per minute (R), needles per 1 inch width (D) and inches per minute of material traveled (S), where PPSI=(R×D)/S. In one embodiment, the composite web is needlepunched to a penetration of 400 PPSI, with a range of 300-500 needles per square inch. A high penetration of a needle per square inch and a high puncture density decreases the resiliency of the composite web, as it would compress the metal and nonmetal fibers to a greater degree. While pests are prevented form dissembling the composite web due the interengagement of the fibers, radial resiliency of the composite web maintains an obstruction level for pests. Therefore, a lower puncture density can rely more on the heat fusing step below for strength and compressibility to spring back to a thickness, as the nonmetal fibers adhere to other nonmetal fibers and metal fibers. Pests can become entrapped in the interengaged mixture of fibers; alternatively pests are prevented from disassembling the composite web due to the interengagement of the fibers.

FIG. 1 shows one embodiment of the needle punched composite web 10. The needle punching of the multi-layered structure 68 interengages the fibers of respective layers, giving the resulting composite web improved strength, fiber density, and resiliency. The needling process causes the metal 20 and nonmetal 22 fibers to be interengaged in and between the layers (in the “z” direction relative to the layers, as shown in FIG. 6). Because the fibers of the composite web are interengaged in the x and y axes during the carding step, the resulting, needle-punched fabric has the fibers interengaged in the x, y, and z directions to form an isotropically strong, coherent composite structure having desirable properties of resiliency and durability.

The needles 76 and 80 of the needling punching apparatus 72 includes a gauge, a barb, a point type and a blade shape (i.e. pinch blade, star blade, conical, and the like). The gauge of the needles is defined as the number of needles that can be fitted in a square inch area. In one embodiment, the gauge of the needle may be between about 20 to about 40 gauge with a regular barb. The major components of the needle include the crank, the shank, the intermediate blade, the blade, the barbs, and the point. The crank is the 90 degree bend on the top of the needle and seats the needle when inserted into the punch boards 74 and 78. The shank is the thickest part of the needle. The shank is that part of the needle that fits directly in the punch board itself. The intermediate blade is put on fine gauge needles to increase flexibility, which is typically put on 32 gauge needles and finer. The blade is the working part of the needle and is what passes into the multi-layered structure 68 and is where the all barbs are placed. The barbs carry and interlock the metal and nonmetal fibers. The shape and sized of the barbs can dramatically affect the composite web 10. The point is the very tip of the needle. In one embodiment, the felting needles are 32 gauge regular barb needles with a pointed end including three sided needles with 3 barbs per blade.

As the punch boards 74 and 78 move up and down, the blades of the needles 76 and 80 penetrate the multilayered web structure 68, as shown in FIG. 6. Barbs on the blade of the needles 76 pick up the metal and nonmetal fibers on the downward movement and carry these fibers through the depth of the penetration. The draw roll pulls the multi-layered structure 68 through the needle punching apparatus 72, as the needles reorient the metal and nonmetal fibers. Generally speaking, the more the needles 76 and 80 penetrate the multi-layered structure 68, the denser and more resilient the composite web 10 becomes; however, beyond some point, damage may result to the metal and nonmetal fibers from excessive needle penetration and decreased resiliency.

The needle punching apparatus 72 includes machine variables of the depth of penetration and puncture density. The travel of the metal and nonmetal fibers through the composite web depends on the depth of penetration of the needles 76 and 80. The maximum penetration is fixed by the needles 76 and 80 of the needle punching apparatus 72 and depends on the length of the three sided shank, the distance between the needle plates, the height of stroke, and the angle of penetration. The greater the depth of penetration, the greater the entanglement of fibers is within the multi-layered structure 68, because more barbs are employed per penetration. In one embodiment, the penetration depth may be between about ½ of an inch to about 1 inch.

The puncture density is the number of punches on the surface of the feed in the web. The puncture density is a complex factor and depends on the density of needles in the needle board (Nb), the rate of material feed (V), the frequency of punching (F), the effective width of the needle board (W), and the number of runs. The puncture density per run Edₚₐₛₛ=[n*F]/[V*W], where, n=number of needles within the punch boards, F=frequency of punching, V=rate of material feed, and W=effective width of the needle board. The puncture density in the needled fabric Ed_{NV} depends on the number of runs Nₚₐₛₛ; Ed_{NV}=Edₚₐₛₛ*Nₚₐₛₛ. The frequency of punching is formulated in the PPSI formula. The thickness, basis weight, bulking density and air permeability provide information about compactness of composite web and are influenced by a number of factors. If the basis weight of the composite web and puncture density and depth are increased, the composite web density increases and air permeability is reduced (when finer needles and longer, finer and more tightly crimped fibers are used). Preferably, the basis weight of the composite web, puncture density, and penetration depth are maintained to result in a resiliency greater than steel or copper wool. In one embodiment, the needles per inch width are 96 needles and the resiliency of the composite web is about 2 to 5 times greater than steel or copper wool.

As far as the strength of the composite web, the situation is similar to that for compactness, namely that finer needles, finer and longer fibers, greater composite web basis weight and greater puncture depth and density, result in increased strength and resiliency of the composite web. However, once a certain critical puncture depth or density has been reached, the rise in strength and resiliency may be reversed. If the depth of the barb is decreased or the distance between the barbs is increased, the dimensional stability is improved during needling, and the web density, resiliency, and maximum tensile strength in relation to basis weight can be raised. The resiliency of the composite web is determined from the penetrations per square inch (“PPSI”), the needle penetration depth, and the type of needles that are being used. The frequency of needle punching is part of the equation for figuring out the PPSI, as indicated above. Alternative punching apparatuses include different needle densities and different needle patterns, which affect the tightness or resiliency of the composite web.

In one embodiment, a heat-fusing step fuses at least a portion of the nonmetal and metal fibers at their intersections to increase the resiliency, strength, and durability of the composite web. As shown in FIG. 7, a heat-fusing step may be carried out after the needle-punching step by heating the composite web to a predetermined temperature that is at least equal to the melting point of the synthetic fibers. In one embodiment, the temperature is from about 10 to 50° C. or more above the melting point of the synthetic fibers. Heat is conducted to the composite web for an amount of time sufficient to cause the outer surface of the synthetic fibers to at least partially melt so that upon cooling the synthetic fibers fuse to other fibers with which they are in contact. Upon heating the nonmetal fiber, the different molecular orientations in the fiber will exhibit different shrinkage behaviors that result in a random, three dimensional crimp in the fiber. This heat induced or latent crimp is induced upon application of heat to the nonmetal fiber and the degree of crimp depends on the temperature to which the nonmetal fiber is subjected. And such a heat fusing of the nonmetal fibers with metal fibers in the composite web increases the strength and resiliency in the composite web for gripping to cracks and crevices. The adhesive nature of the nonmetal fibers can be selected to increase the resiliency of the composite web when subjected to the heat fusing step.

With reference to FIG. 7, the heating step may be carried out by passing the composite web through a pinch roll apparatus comprising a heat-conductive roll 84 and a resilient (e.g., rubber) roll 86, with the clearance between the pinch rolls set to at least partially compress the composite web while it is in contact with the heated pinch roll. The amount of time the composite web spends in contact with the heated roll may be adjusted depending on the amount of melting of the synthetic fibers desired. The composite web may contact the heated roll between 3 and 10 seconds. As will be appreciated, the amount of fusion between the fibers will be greatest at the surface contacting the heated roller. Optionally, two or more such pinch roll devices may be used in series so that both surfaces of the composite web are brought into direct contact with a heat conductive roll 84 to fuse the fibers of the composite web 10. The resulting composite web 10 can have thickness between ⅛ inch to 1 inch. Such thicknesses are to be determined based upon the pest deterring properties desired.

Other methods of heating and melting the synthetic fibers include compressed hot air, direct radiant heating such as with an oven, or laminating the nonmetal fibers with adhesives. “Laminating” means securing nonmetal fibers together or to metal fibers by any adhering process, such as heat application, adhesives, pressure, mechanical bonding, or any combinations thereof. Laminating forms a bond between two surfaces; this may be a thermal bond, a chemical bond, or a mechanical bond. Adhesives may be any suitable material that is compatible with the nonmetal fiber and the metal fiber. Laminating the nonmetal fiber and the metal fiber increases the stability, strength, and deterring properties of the composite web 10.

The density of the metal and nonmetal fibers 100 to about 3000 g/m². By needle punching, lapping, and laminating the composite web 10, the required density for the desired pest exclusion operation can be obtained. For large pests, a higher density of 2500 g/m² to result in an increased resiliency. For smaller pests, a lower density of 500 g/m² may be desired to squeeze the composite web into smaller holes or passageways. Alternatively, the composite web may include a density gradient, whereby one end of the composite web includes an increased density of 1000 to about 2000 g/m², and another end of the composite web includes a lower density of about 500 to about 1000 g/m². Such a gradient density allows for the composite web to be inserted in a small hole or passageway with the lower density end, while the higher density end is able to deter larger pests with an increased resiliency.

### Composite Web Examples

The following examples are put forth so as to provide those of ordinary skill in the art with a complete disclosure and description of how the articles, devices, systems, and/or methods claimed herein are made and evaluated, and are intended to be purely exemplary and are not intended to limit the scope of articles, systems, and/or methods. Efforts have been made to ensure accuracy with respect to numbers (e.g., amounts, temperature, etc.), but some errors and deviations should be accounted for.

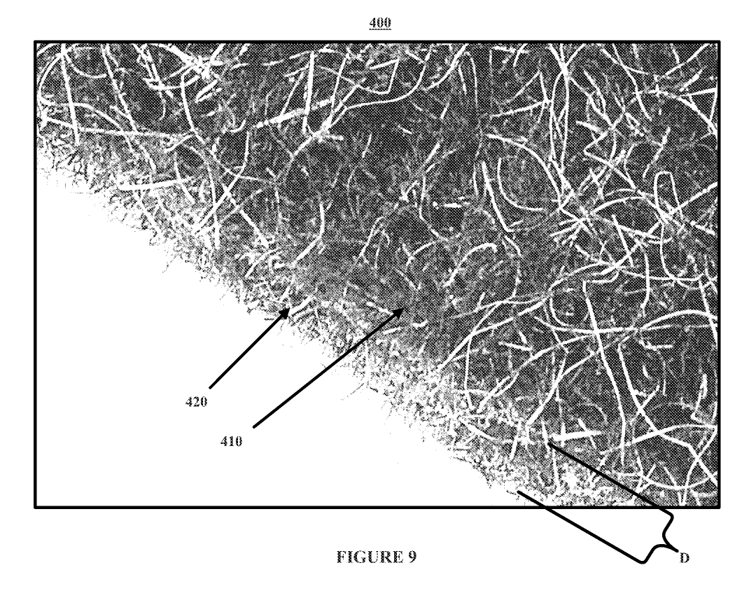

In one embodiment, the composite web 400 includes stainless steel metal fibers 410 and 18 denier polyester fibers 420, as shown in FIG. 9. The ratio of metal fibers to nonmetal fibers is 9:1 by weight, where the composite web 400 has a total basis weight of 1700 g/m². The composite web 400 is needle punched to ¼ inch in thickness D. In another example, the composite web includes stainless steel metal fibers and 18 denier bicomponent fibers. The ratio of metal fibers to nonmetal fibers is 9:1 by weight to give a total basis weight of 1700 g/m² to the composite web. The needle punched composite web is heat activated by the heat fusing step to give the composite web a thickness of ½ inch. In another example, the composite web includes stainless steel metal fibers and 18 denier bicomponent fibers. The ratio of metal fibers to nonmetal fibers is 9:1 by weight, to give a total basis weight of 1200 g/m². The needle punched composite web is heat activated by the heat fusing step to give the composite web a thickness of ¼ inch.

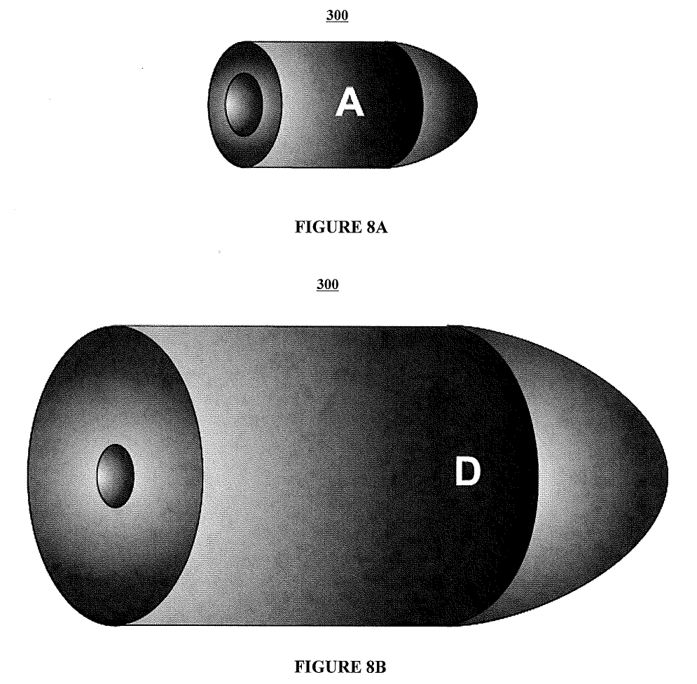

Additionally, the composite web can be molded into three dimensional shapes, such as cones or bullet shaped plugs 300, as shown in FIGS. 8A and 8B. The bullet shaped plugs 300 may be of any desired size depending upon the application of pest exclusion. The A bullet shaped plug in FIG. 8A may plug a 1 inch hole, while the larger B bullet shaped plug in FIG. 8B may plug an about 1 to about 1.5 inch hole. The cylindrical structure is either spherical ellipsoidal or any other nonplanar suitable shape for pest exclusion. The multilayered composite web structure 68, as shown in FIG. 5, is taken into a mold or mask to form a cylindrical structure upon heat activation. The multilayered composite web structure is then subjected to a heat fusing step to activate the nonmetal fibers to fuse to other nonmetal and metal fibers as to form the mold. In one embodiment, the application of heat may be through an oven. Upon cooling, the composite web will be set cone or bullet shaped plug of a selected size and shape to be resilient to deter pests. Alternatively, kits with the molds can be sold to users for creating their own specified shaped mold and size.

If desired, the composite may optionally include various additives, such as insect repellents and animal repellents, which may enhance the performance of the composite as a deterrent agent. Additionally, the composite web 10 may molded and adhered to various structures by any desirable fashion. For example, the composite web 10 may be adhered to an opening by plug fitting the composite web 10 with sufficient resiliency that the composite web 10 provides a pest barrier. Alternatively, the composite web 10 may be tacked, stapled, glued, or laminated to a crack, crevice, or gap.

It will be apparent to those skilled in the art that various modifications and variations can be made without departing from the scope or spirit of the embodiments described herein. Other embodiments will be apparent to those skilled in the art from consideration of the specification and practice of the embodiments disclosed herein. It is intended that the specification and examples be considered as exemplary only, with a true scope and spirit of the embodiments being indicated by the following claims.

What is claimed is:

1. A composite for pest deterrence comprising:
a. a plurality of metal fibers and a plurality of nonmetal fibers, wherein the metal fibers interengage with each other and the nonmetal fibers; and the metal fibers include a plurality of barbed projections and a rough barbed outer surface with irregular shaped cross-sections varied along the lengths of the metal fibers;
b. wherein the interengaged mixture of metal and nonmetal fibers form a pest deterrence composite.

2. The composite of claim 1, wherein at least a portion of the nonmetal fibers are laminated to the metal fibers.

3. The composite of claim 1, wherein the metal fibers and nonmetal fibers are needlepunched to provide for a resiliency to return to an original shape after compression.

4. The composite of claim 1, wherein the metal fibers include a cross sectional diameter of between about 25 to 125 microns.

5. The composite of claim 1, wherein the ratio of metal fibers to nonmetal fibers is between about 10:1 to about 8:1.

6. The composite of claim 1, wherein the metal fiber is a stainless steel metal fiber.

7. A composite web for pest deterrence comprising:
a. at least one homogenous web including at least two overlapping layers, wherein each of the layers is an interengaged mixture of metal and nonmetal fibers, wherein the metal fibers include barbed projections and a rough outer surface with irregular shaped cross sections varied along the length of the metal fibers;
b. the adjacent layers are interengaged with one another to form a pest deterrence composite web.

8. The composite web of claim 7, wherein at least a portion of the nonmetal fibers are laminated to the metal fibers.

9. The composite of claim 7, wherein the metal fibers and nonmetal fibers are needlepunched to provide for a resiliency to return to an original shape after compression.

10. The composite of claim 7, wherein the metal fibers include a cross sectional diameter of between about 25 to 125 microns.

11. The composite of claim 7, wherein the ratio of metal fibers to nonmetal fibers is between about 10:1 to about 8:1.

12. The composite of claim 7, wherein the metal fiber is a stainless steel metal fiber.

13. A method for deterring pests including:
a. providing an interengaged mixture of metal and nonmetal fibers, wherein the metal fibers include a plurality of barbed projections and a rough barbed outer surface with irregular shaped cross-sections varied along the lengths of the metal fibers; and
b. adapting the interengaged mixture of metal and nonmetal fibers to deter pests.

14. The method of claim 13, wherein at least a portion of the nonmetal fibers are laminated to the metal fibers.

15. The method of claim 13, wherein the metal fibers and nonmetal fibers are needlepunched to provide for a resiliency to return to an original shape after compression.

16. The method of claim 13, wherein the metal fibers include a cross sectional diameter of between about 25 to 125 microns.

17. The composite of claim 13, wherein the ratio of metal fibers to nonmetal fibers is between about 10:1 to about 8:1.

18. The composite of claim 13, wherein the metal fiber is a stainless steel metal fiber.
